(19) United States
(12) Patent Application Publication
(10) Pub. No.: US 2026/0257437 A1
(43) Pub. Date: Sep. 3, 2026

(54) METHOD FOR PRODUCING AN OPTICAL ARRANGEMENT COMPRISING AN OPTICAL WAVEGUIDE AND AN OPTICAL COMPONENT

(71) Applicant: Tooz Technologies GmbH, Aalen (DE)

(72) Inventors: René HENSEL, Aalen (DE); Enrico GEISSLER, Jena (DE); Andrea BERNER, Jena (DE)

(21) Appl. No.: 18/881,725

(22) PCT Filed: Jun. 30, 2023
(86) PCT No.: PCT/EP2023/068110

§ 371 Date: Jan. 6, 2025

(30) Foreign Application Priority Data
Jul. 7, 2022 (DE) 10 2022 117 022.5

(51) Int. Cl. B29D 11/00; G02B 27/01

(52) U.S. Cl. CPC B29D 11/00692; B29D 11/00673; B29D 11/0073; G02B 27/0172; G02B 2027/0138; G02B 2027/0194

(57) ABSTRACT

A method for producing an optical arrangement includes providing an optical waveguide and an optical component. The respective surfaces of the optical waveguide and the optical component are designed for mutually facing arrangement and having a surface geometry matched to one another. A mask is provided to cover the edge region of the surface of the optical waveguide and the rear-side surface of the optical component at least in part. The mask is arranged on the surface of the optical waveguide or the rear-side surface of the optical component such that the edge region of the surface is covered at least in part. An adhesive is applied to the surface of the optical waveguide or the rear-side surface of the optical component. The rear-side surface of the optical component and the surface of the optical waveguide are placed against one another, the adhesive cured and the mask removed.

### PRIORITY

This application claims the benefit of German Patent Application No. 10 2022 117 022.5 filed on Jul. 7, 2022, which is hereby incorporated herein by reference in its entirety.

### FIELD

The present invention relates to a method for producing an optical arrangement, an optical arrangement, an image capture apparatus and an image reproduction apparatus.

### BACKGROUND

Head-mounted displays, for example in the form of smartglasses or AR (augmented reality) headsets or VR (virtual reality) headsets or MR (mixed reality) headsets or AR or VR or MR glasses or AR or VR or MR helmets, are used in numerous contexts. In this context, after light waves for creating a virtual image have been input coupled into an optical waveguide, they are usually guided by means of total-internal reflection until they are output coupled. When a user looks through “augmented reality glasses”, or “AR glasses” for short, they see an input coupled or superimposed “virtual image” overlaid on their image of the physical world (“real image”). This overlay is achieved by way of a beam combiner which, on the one hand, is transparent to ambient light but, on the other hand, also steers a beam created by an external picture generator to the eye of an observer or into an eye box. The eye perceives this beam as a virtual image.

The scope of the various optical applications sees a virtual image transmitted by means of an optical waveguide and output coupled from the optical waveguide into the beam path of a real image representation of the surroundings toward an eyebox or toward the eye of an observer. This usually requires an optical arrangement which comprises the optical waveguide and at least one further optical component connected therewith or element, for example in the form of a lens, in particular a lens for a pair of glasses, or a viewing window. Examples of such applications include head-mounted displays (HMDs), head-up displays (HUDs) and near-to-eye displays. Further applications requiring an optical waveguide and at least one further optical component connected therewith include imaging arrangements or imaging apparatuses (smartglasses for example including gesture recognition or eye tracking).

An optical waveguide (light guide) is understood to mean a waveguide designed to guide or transmit light waves through the waveguide in the interior thereof by way of total-internal reflection at the waveguide surfaces. Light waves are understood to mean electromagnetic waves at wavelengths in the range between 300 nm (ultraviolet light) and 2 μm (infrared light), in particular light waves in the visible range and near infrared range and near ultraviolet range.

The region in space from where the virtual image is visually perceivable by an observer is also referred to as an eyebox. The two outer surfaces of the optical waveguide are frequently in the form of parallel plane faces so that neither optical refractive power is introduced nor aberrations, which impair the image quality, are created within the optical waveguide.

By preference, the so-called push/pull lens concept is used to correct the refractive error, e.g. ametropia or presbyopia, of the user of a head-mounted display (HMD), e.g. AR, VR or MR glasses or an AR, VR or MR helmet. In this case, the HMD consists of two lenses (push lens and pull lens) for glasses and an optical waveguide situated between the lenses (see FIG. 1). The light of the virtual image input coupled from a display or picture generator is transported by the waveguide to in front of the eye of the observer, where this light is output coupled toward the eye or into an eyebox. The pull lens can pull the virtual image to the observer. The push lens corrects the refractive power of the pull lens for the real image representation of the surroundings, i.e. the scene surrounding an observer. In addition, the pull lens can be designed to correct a refractive error of the observer. Thus, the pull lens and/or the push lens can allow implementation of a visual correction in the event of a refractive error associated with the observer. No push lens is required if the intention is to image the virtual image at infinity.

The optical waveguide function requires total-internal reflection of the image-generating beams at opposing surfaces. The surfaces can have a plane or curved embodiment. In principle, the present invention in certain embodiments can be applied to both variants. A small critical angle for total-internal reflection enables a large field of view (FOV). A small critical angle requires a sufficiently large refractive index difference between the optical waveguide and the adjacent medium. This precludes directly connecting the push/pull lenses to the optical waveguide since these components consists of similarly high-index materials, i.e. materials with a high refractive index. Low-index media, i.e. materials with a low refractive index, can be introduced as an intermediate layer. Examples include air (or gases in general) with a refractive index of 1 or highly fluorinated liquids or solids with refractive indices ranging from 1.29 to 1.4. The following variants are known as regards the technical realization of such a material compound structure: All-over adhesive bonding using a low-index adhesive is described in documents DE102016105060B3 and US2020183170A1. The use of an air gap between lens and optical waveguide is disclosed in documents US2021364802A1, U.S. Pat. Nos. 10,108,011B2, 10,845,616B2, WO2018166921A1, U.S. Pat. Nos. 10,466,483B2, 10,007,115B2 and 10,859,837B2. The use of permanent spacers for setting the distances between lenses and optical waveguides is explained in documents U.S. Pat. Nos. 11,262,585B2, 10,108,011B2 and WO2004001484A1. Use of recesses for passive alignment of the optical components is described in document U.S. Pat. No. 9,568,734B1. Molding the optical waveguide with liquid lens material and subsequent curing is explained in documents U.S. Pat. Nos. 10,509,155B2, 7,022,268B2, 7,800,827B2, EP2418073B1, U.S. Pat. No. 10,288,907B2.

Molding and recesses are usually not provided all over and include the following disadvantages: The boundaries of the optical waveguide or of the recesses are visible, especially if a low-index medium surrounds the waveguide in order to ensure total-internal reflection. The lens material (e.g. polymer) is subject to much greater thermal expansion than the optical waveguide (e.g. consisting of glass). In the compound structure, the optical waveguide loosens at elevated temperatures, or thermal compressive stresses arise at lower temperatures. Moreover, a specific disadvantage of molding is that the lens material cures at elevated temperatures, and this can lead to stresses and possibly to a deformation of the optical waveguide during the cooling to room temperature. Recesses additionally require mechanical processing of the lens back side while observing tight tolerances.

An air gap is usually implemented all over but has the following disadvantages: The compound structure of the optical components containing an intermediate air gap is mechanically more unstable than an adhesive connection since there is neither a force fit nor a form fit. However, a possible compensation by means of thicker lenses and waveguide leads to a greater weight and a lower comfort of wear. Total-internal reflection in the waveguide, and hence the virtual image and the function of the HMD, are disturbed in the event of contact between a lens that has been bent as a result of external pressure and the optical waveguide. Moreover, there is the risk of the function of the HMD being impaired by possible condensation of water in the air gap. Moreover, the air gap requires two anti-reflection layers per waveguide/lens transition in order to avoid optical disturbances such as ghost images, for example.

Permanent spacers are used to realize homogeneous distances and a homogeneous layer thickness. They remain permanently in the compound structure and form potential sources of scattered light and a disturbance of the total-internal reflection should the refractive index not be matched to the surrounding medium and/or the refractive index difference between spacer and waveguide not be sufficiently high.

All-over adhesive bonding therefore forms the preferred solution according to certain embodiments of the present invention since, for example, mechanical stability is also provided in the event of thinner lenses; however, the specific process of an implementation for the applications described at the outset has not yet been described to date. However, the following needs to be considered: The use of adhesives with a low refractive index (“low-index adhesive”) harbors the risk of poor adherence of the low-index adhesive to the optical components if the surfaces are not pretreated. Low-index adhesives with refractive indices <1.4 are usually fluorinated. The higher the fluorine content, the lower the refractive index (1.3 is the lower limit). However, fluorine reduces the adhesion in comparison with fluorine-free adhesives. Most fluorinated adhesives contain methacrylate or acrylate groups and can be cured by UV irradiation. A defined, homogeneous layer thickness is desired in order to avoid interference effects. It is undesirable to have the adhesive leaking from the edge as this makes integration into a glasses frame more difficult. Good positioning and alignment of the optical components should be ensured and also a homogeneous exposure of the adhesive layer during curing.

### SUMMARY

An object herein is making available an advantageous method for producing an optical arrangement, an optical arrangement, an image reproduction apparatus and an image capture apparatus.

A method for producing an optical arrangement comprising at least one optical waveguide and at least one optical component is provided herein. The optical component is an optically effective component, i.e. a component which manipulates or modifies a wavefront in a beam path, for example a lens or a diffractive optical element or a holographic optical element or a refractive lens or a Fresnel lens or a GRIN element or an input coupling device, in particular an input coupling prism. The optical arrangement can be designed or destined for optical equipment set forth at the outset, for example for a head-mounted display (HMD), e.g. AR, VR or MR glasses or an AR, VR or MR helmet.

The method in certain examples comprises the following steps: An optical waveguide with a surface, which can be a front-side or back-side surface, and an optical component with a back-side surface are provided. In this case, the surface of the optical waveguide and the back-side surface of the optical component are designed for arrangement on one another in a manner facing one another and have a surface geometry matched to one another. The surface geometry matched to one another can be designed for interlocking placement of the two surfaces on one another.

At least one mask is provided in a further step, which can be carried out before or after or simultaneously with the above-described step. In the context of the present invention, a mask is understood to be a component that is designed to cover a region of a surface. The mask is designed to at least partly cover, advantageously completely cover, the edge region, in particular the all-round edge region, of the surface of the optical waveguide and of the back-side surface of the optical component. The mask can advantageously completely cover the all-round edge of the surface of the optical waveguide and by contrast only partly cover the back-side surface of the optical component. The geometry of the mask can be matched to the geometry of the waveguide or of the optical component, in particular to the geometry of the edge regions, for example in order to facilitate an adjustment of the mask.

In a subsequent step, the mask is arranged on the surface of the optical waveguide or on the back-side surface of the optical component, in such a way that the edge region of the surface is at least partly covered, advantageously completely covered. By preference, the mask is secured to the respective surface, for example adhesively bonded thereon.

In a subsequent step, an adhesive is applied to the surface of the optical waveguide or to the back-side surface of the optical component, preferably to the surface on which the mask is arranged. The adhesive is therefore applied to the respective masked surface. In the process, the adhesive can be introduced into an opening in the mask. In so doing, the opening can be completely filled with adhesive, i.e. be at least completely filled with adhesive, in this step or following the subsequent step. In a next step, the back-side surface of the optical component and the surface of the optical waveguide are placed on one another. This can be a floating placement, especially in order to distribute the adhesive uniformly. Stops can be used to adjust the position. The adhesive is cured in a next step. The mask is removed after curing.

The method has the following advantages: It enables a homogeneous adhesive layer thickness and simple manufacturing of a precisely adjusted and secure connection between the optical waveguide and the optical component, for example a push lens and/or pull lens. The aforementioned disadvantages of air gaps and permanent spacers are avoided. It is possible to manage without the implementation of recesses in the back side of the optical component, e.g. the lens, in the event of a whole-area compound structure. The fabricated optical arrangement has a low weight and high mechanical stability. The mechanical stability of the compound structure allows the use of very thin lenses. Areal adhesive bonding increases the mechanical stability of the compound structure and prevents pressure contact of lenses and waveguide even in the event of very thin lenses.

Masking can prevent undefined leakage of the adhesive and can thus avoid cleaning steps. A homogeneous adhesive gap thickness and/or an adhesive-free edge is ensured by the mask.

In particular, there can be no need for post-processing of the adhesively bonded compound structure, for example in order to implement the refractive power of the optical component, e.g. the lenses, or perform edging for integration in a glasses frame. The present case also does not require post-processing of the lens surfaces or edging following the connection to the optical waveguide, as is conventional in the event of e.g. molding. This avoids an additional action of force on the connection area. A short tolerance chain (the sum of all tolerances of the involved individual parts and processes) is achieved should identical reference areas (e.g. the contour of the optical waveguide) be used for manufacture, adjustment and integration.

In an advantageous variant, the mask comprises a frame, preferably a closed frame, for example with an all-round edge, and an opening arranged in the frame, for example an opening in the form of a passage opening. Moreover, the mask can comprise a number of projections, i.e. at least one projection, preferably three projections. In this variant, the number of projections extend from the frame or edge into the opening. Thus, at least one projection that extends into the opening is present in this variant. The projection or the projections can be designed as bulge(s), for example. For example, the opening in the mask can be smaller than the back-side surface of the optical component, in particular such that on the outside the lens can rest on the mask in full. It is also possible to combine this variant with further spacers. The projections can also cover only a portion of the aforementioned surface of the optical waveguide and/or of the back-side surface of the optical waveguide. Otherwise, the geometry of the opening can preferably be matched to the outer edge of the surface to be masked, i.e. the surface of the optical waveguide or the back-side surface of the optical component.

A further option consists of using a separate mask to cover each of the surface of the optical waveguide and the back-side surface of the optical component on an individual basis. This harbors the advantage that excess adhesive can leak out between the two masks when the aforementioned surfaces are placed on one another and can therefore be removed together with the masks.

The surface of the optical waveguide can comprise a zone (optically active region) designed for total-internal reflection. The mask can be embodied such that the area that is not covered by the mask, for example the cross-sectional area of the opening, is matched to the zone designed for total-internal reflection, for example corresponds to the latter or has a geometry that is identical or similar to the latter. In a particularly advantageous exemplary embodiment, the area that is not covered by the mask, for example the opening in the mask, corresponds to at least one region of the optical waveguide in which total-internal reflection needs to be ensured. This variant is advantageous because the low-index adhesive, which has lower adhesion in comparison with other adhesives, need not be used all over and the surface regions located outside of the region in which total-internal reflection must be ensured can be adhesively bonded using a different adhesive. Overall, this achieves improved adhesion between the optical waveguide and the optical component.

In an advantageous variant, an optical component that is fully manufactured in relation to the optical effect, in particular the geometry and/or the refractive power distribution, is provided as optical component. The optical effect can optionally comprise possible coatings. However, this is not mandatory. Possible coatings of the surface can have already been applied or can be applied following the curing of the adhesive and/or following the removal of the mask. The surfaces of the optical component are already shaped so that they provide a required optical effect, e.g. for correcting a refractive error. By preference, the edge of the optical component is also completed, for example for subsequent fitting into a frame or a glasses frame. This is advantageous in that there is no need for post-processing of the adhesively bonded compound structure. By preference, the manufacture of the optical waveguide has also been completed. Thus, completed means that the geometric shape (surface shape at the front, back and on the side faces) and resultant optical effect are provided in advance of adhesive bonding. This allows simple and cost-effective further processing, for example by an optician. For example, an optician can also be able to carry out the method according to the invention.

In a further variant, an optical component that comprises a coated front-side surface can be provided as optical component. For example, the front-side surface here can have at least one coating, e.g. an antireflective coating, an antifog coating, a scratch resistant coating, etc.

Advantageously, the adhesive can be cured through the optical component, for example by means of UV light. To this end, it is possible to choose light at a wavelength that is transmitted by the optical component. By preference, curing is implemented all over. Areal exposure through the optical component, e.g. the lens, enables homogeneous curing but requires observation of the aforementioned boundary conditions.

The depressions between the optical waveguide and the optical component in the created adhesive layer that are caused on account of the mask can be filled with adhesive. This relates in particular to depressions that have arisen on account of the mask projections as a result of mask removal, i.e. depressions caused by the mask projections that extend into the mask opening, for example. Filling is advantageous in that a complete adhesive layer is present, and possible disturbances or aberrations as a result of the depressions that have arisen are avoided. Thus, the result is a compound structure without optical interfering points since no spacer materials remain in the adhesive layer and hence in the field of view of the observer.

In a further variant, removal of the mask can be followed by the introduction between the surface of the optical waveguide and the back-side surface of the optical component of a further adhesive with a composition that deviates from the adhesive applied previously. Thus, a different adhesive can be used for filling-up purposes, for example in order to increase mechanical stability. By preference, the refractive index of this adhesive is matched to the refractive index of the optical waveguide, the lens or the first adhesive. Should the first adhesive, i.e. the adhesive designed for adhesively bonding zones designed for total-internal reflection, have a low refractive index, it can have lower mechanical strength, e.g. in the case of a thermal load, than other adhesives. The further adhesive may have greater strength. As already described previously, the further adhesive can be applied for example to surface regions of the optical waveguide that form zones not designed for total-internal reflection and therefore does not need to have a low refractive index.

Advantageously, use is made of an adhesive with a refractive index of between 1.3 and 2.0, preferably between 1.3 and 1.5, particularly preferably between 1.3 and 1.4. By preference, the refractive index is smaller than the refractive index of the waveguide in order to ensure total-internal reflection in the waveguide at small critical angles and thus enable a large field of view. The width of a free boundary optionally created by the at least one mask, for example the width of a free circumferential boundary, on the optical waveguide or the optical component is preferably less than 10 mm, preferably less than 1.5 mm. It can also be avoided in its entirety by virtue of the edge of the mask opening geometrically corresponding to the outer contour of the optical waveguide and/or the optical component, i.e. by virtue of only the projections being arranged on the respective surface.

For example, a lens can be provided, and/or an optical element designed to correct a refractive error in an imaging path of a real image representation of the surroundings and/or to correct a refractive error in an imaging path of a virtual image representation and/or to focus a virtual image representation in an imaging path of a virtual image representation can be provided, as optical component. The lens and/or the optical element can have a refractive and/or diffractive embodiment. In particular, the lens can be in the form of a push lens and/or a pull lens.

The optical component, e.g. the push lens and/or pull lens, can consist of plastic or of glass. The maximum edge and/or central thickness of the optical component, e.g. the lens, is advantageously less than 1.5 mm; it is preferably less than 1 mm.

In a further variant, an optical component which comprises a back-side surface with a plane or curved embodiment is provided as optical component, and an optical waveguide which comprises a surface with a plane or curved embodiment is provided as optical waveguide. By preference, the back-side surface of the optical component and the surface of the optical waveguide both have a planar embodiment or both have a curved embodiment.

Advantageously, an optical component with an oxidic back-side surface, e.g. a back-side surface with an oxidic coating, is provided as optical component. In addition to that or in an alternative, an optical waveguide with an oxidic surface, e.g. a surface with an oxidic coating, can be provided as optical waveguide. In particular, the back-side surface of the optical component and/or the surface of the optical waveguide can have an oxidic coating, e.g. a quartz layer, or be provided with an oxidic coating within the scope of the present method or have an oxidic embodiment, i.e. comprise oxidic material. The quartz layer offers the basis for a silane attachment of non-oxidic lens material. Other oxidic layers or materials are also suitable. The smaller refractive index difference in an adhesive/lens interface and an adhesive/waveguide interface when compared with an air/lens or air/waveguide interface also means that a potential antireflective coating between lens and optical waveguide can be omitted or kept simple.

An oxidic embodiment described is advantageous in that optimal chemical bonding with the material of the adhesive is achieved. To this end, preferably, the oxidic surface or the oxidic coating is activated for the creation of reactive groups and subsequently coated with a suitable silane.

The mask can be manufactured on an individual basis within the scope of the present method, for example by cutting the mask. For example, polymer films such as vinyl, polyvinyl chloride, silicone, polyacrylate, polyethylene terephthalate and polyolefin films can be used as mask material. Moreover, fluorinated and perfluorinated films can be used. By preference, the films are self-adhesive or adhere sufficiently to the applied surface. By preference, the mask has a thickness of between 1 micrometer and 1 millimeter.

The mask can be arranged by means of a gripper. The adhesive can be introduced into the opening by means of a dispenser or a positive displacement pipette.

The position of the optical waveguide and/or the mask and/or the optical component in relation to at least one other of the aforementioned components can be adjusted by means of at least one mechanical stop. Adjustment is preferably implemented following the application of the adhesive and following the placement of the back-side surface of the optical component and the surface of the optical waveguide on one another.

By preference, use is made of an adhesive with a lower refractive index than the optical waveguide, or use is made of an optical waveguide that comprises a coating having a material that has a lower refractive index than the optical waveguide. This ensures the functionality of the optical waveguide on account of total-internal reflection.

The optical arrangement can be produced according to an above-described method. The optical arrangement can be embodied as a viewing window, e.g. a lens for a pair of glasses, for output coupling a virtual image representation in the direction of an eyebox. The optical arrangement has the features and advantages that have already been described in connection with the methods.

The image reproduction apparatus comprises an above-described optical arrangement. The image reproduction apparatus can be an HMD, e.g. AR or VR or MR glasses or an AR or VR or MR helmet. The image capture apparatus comprises a previously described optical arrangement. The image capture apparatus can be an imaging arrangement on imaging apparatus (smartglasses with gesture recognition or eye tracking, for example). The image reproduction apparatus and the image capture apparatus have the aforementioned features and advantages.

The invention is explained in greater detail below on the basis of exemplary embodiments with reference to the accompanying figures. Although the invention is more specifically illustrated and described in detail by means of the preferred exemplary embodiments, nevertheless the invention is not restricted by the examples disclosed and other variations can be derived therefrom by a person skilled in the art, without departing from the scope of protection of the invention.

The figures are not necessarily accurate in every detail and to scale, and can be presented in enlarged or reduced form for the purpose of better clarity. For this reason, functional details disclosed here should not be understood to be limiting, but merely to be an illustrative basis that gives guidance to a person skilled in this technical field for using the present invention in various ways.

The expression “and/or” used here, when it is used in a series of two or more elements, means that any of the elements listed can be used alone, or any combination of two or more of the elements listed can be used. For example, if a structure is described as containing the components A, B and/or C, the structure can contain A alone; B alone; C alone; A and B in combination; A and C in combination; B and C in combination; or A, B, and C in combination.

### BRIEF DESCRIPTION OF THE DRAWINGS

FIG. 1 schematically shows a side view of a head-mounted display.

FIG. 2 schematically shows a method according to certain embodiments of the invention in the form of a flowchart.

FIG. 3 schematically shows a masked surface of an optical waveguide or an optical component in a plan view.

FIG. 4 schematically shows the arrangement of an optical waveguide, a mask and an optical component in different views and variants.

FIG. 5 schematically shows the steps of an exemplary method according to certain embodiments of the invention.

FIG. 6 schematically shows, in the form of a diagram, the transmission through an exemplary optical component as a function of light wavelength.

FIG. 7 schematically shows an image reproduction apparatus or image capture apparatus according to certain embodiments of the invention.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

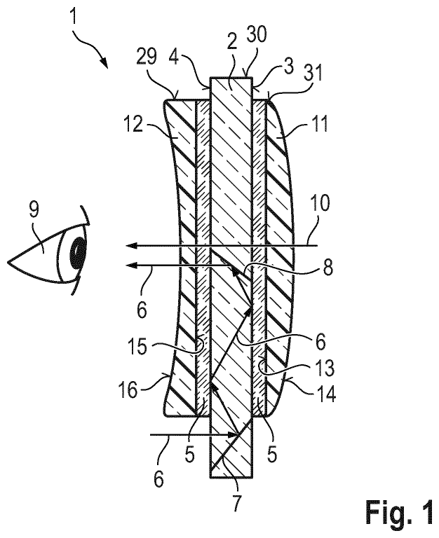

FIG. 1 schematically shows a side view of a head-mounted display 1. The head-mounted display comprises an optical waveguide 2 comprising two opposing surfaces 3 and 4, of which the surface 3 forms a front-side surface and the surface 4 forms a back-side surface in FIG. 1. In the context of the method according to the invention, the designations front side and back side are interchangeable here. Thus, the surface 4 can also be considered to be a front-side surface. A respective layer made of a low-index medium 5, i.e. a material with a low refractive index, e.g. less than 2.0, preferably less than 1.4, is arranged on the two surfaces 3 and 4.

Light whose beam path is labeled by reference sign 6 is input coupled into the optical waveguide 2 via an input coupling device 7. The light 6 is guided by total-internal reflection within the optical waveguide 2 to an output coupling device 8. The output coupling device 8 is used to emit the light 6 toward an eyebox or an eye 9. The beam path 6 labels the imaging path of a radiated-in virtual image representation. The beam path of an imaging path of an image representation of the real surroundings is labeled by reference sign 10. The beam path 10 labels the image representation of the surroundings that a user perceives visually when looking through the HMD 1. A first lens 11, embodied as a push lens in the example shown, is arranged adjacent to the low-index medium 5 on the surface 3 of the optical waveguide 2. A second lens 12, which can be embodied as a pull lens for example, is arranged on the surface 4 of the optical waveguide 2 in the example shown.

The first lens 11 and the second lens 12 each comprise two surfaces arranged opposite one another, wherein, in each case, the surface facing away from the optical waveguide 2 is referred to as front-side surface and the surface facing the optical waveguide 2 is referred to as back-side surface here. The optical waveguide comprises an edge 30, which forms the edge of the surfaces 3 and 4. Thus, the first lens 11 comprises a front-side surface 13 facing away from the optical waveguide 2 and a back-side surface 14 facing the optical waveguide 2 and also an edge 31. The second lens 12 comprises a back-side surface 15 facing the optical waveguide 2 and a front-side surface 16 facing away from the optical waveguide 2 and also an edge 29.

In the example shown, the surfaces 3 and 4 of the optical waveguide 2 and the surfaces 14 and 15 of the lenses 11 and 12 that face the optical waveguide 2 have a plane embodiment. In an alternative, the aforementioned surfaces 3, 4, 14 and 15 can have a curved embodiment.

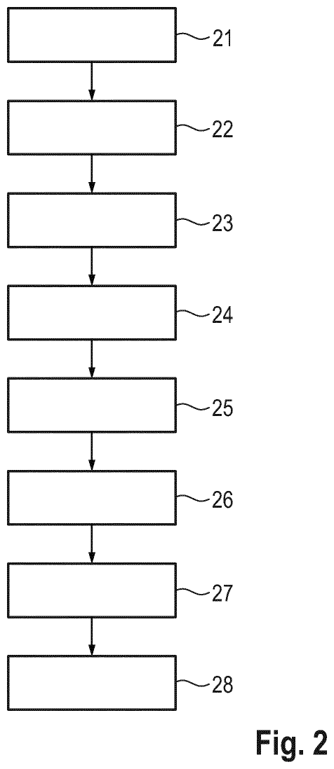

An example of a method for producing an optical arrangement, which comprises at least one optical waveguide 2 and one optical component, for example at least one of the lenses 11 and/or 12 shown in FIG. 1, is described below on the basis of the flowchart shown in FIG. 2. In particular, the method can be used to produce an HMD shown in FIG. 1, in particular to adhesively bond the optical waveguide 2 to one or more lenses 11, 12.

An optical waveguide 2, which has a surface 3, 4, and an optical component 11, 12, for example a lens, which has a back-side surface 14, 15, is provided in a first step 21. The surface 3, 4 of the optical waveguide and the back-side surface 14, 15 of the optical component 11, 12 are designed for arrangement on one another in a manner facing one another and have a surface geometry matched to one another.

A push lens and/or pull lens (optically effective component) made of plastic or glass can be used as an optical component. The optical component or more optical components 11, 12 are produced in accordance with a specified optical design using ultra-precision manufacturing or any other manufacturing methods. By preference, the front-side surface 13, 16 of the optical component 11, 12 is “fully processed” in terms of optical quality before the optical component 11, 12, e.g. the lens, is adhesively bonded to the optical waveguide 2. This case does not require post-processing of the lens surfaces 13, 16 or the lens edging 31, 29 following the connection to the optical waveguide 2, as is conventional in the event of e.g. molding. This avoids an additional action of force on the connection area. Potential coatings (antireflective, antifog, scratch resistant, etc.) are preferably also already applied to the front-side surface 13, 16 and/or the back-side surface 14, 15. In the context of the subsequent curing of the adhesive, it can be advantageous should a UV protective layer be applied only post curing.

The back-side surface 14, 15 of the optical component 11, 12, in particular of the respective lens, is either plane or curved, wherein the curvature of the back-side surface 14, 15 preferably corresponds to the curvature of the surface 3, 4 of the optical waveguide 2. The dimensional accuracy of the optical component, e.g. an unstable individual lens, is achieved e.g. by way of the compound structure with the waveguide. Moreover, no mechanical stop faces or recesses should be provided, e.g. on the lens itself, for the purpose of adjusting the optical waveguide 2.

In an optional configuration, the back-side surface 14, 15 of the optical component 11, 12, in particular of the lenses, is coated with a quartz layer or another oxidic layer within the scope of the surface pretreatment. Following its activation, the quartz layer enables the chemical attachment of silane. The activation can be implemented by means of low-pressure plasma (air or oxygen atmosphere) or atmospheric pressure plasma and ensures reactive groups for covalent bonding of the silane.

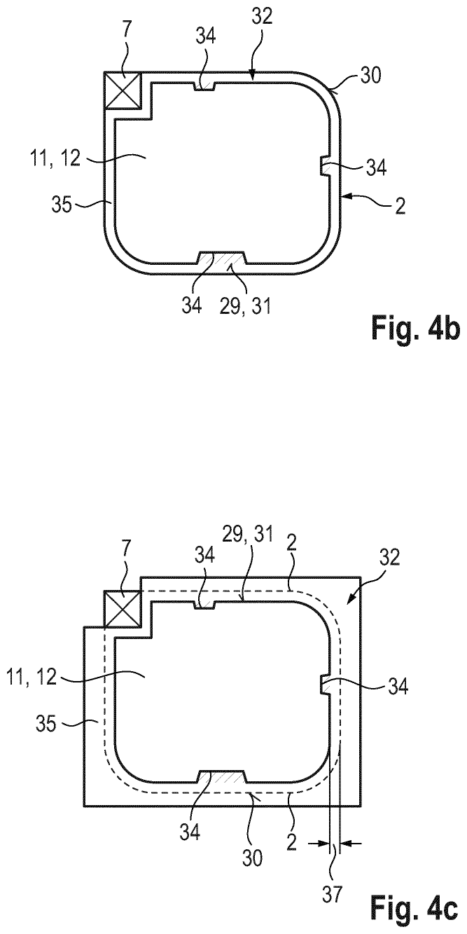

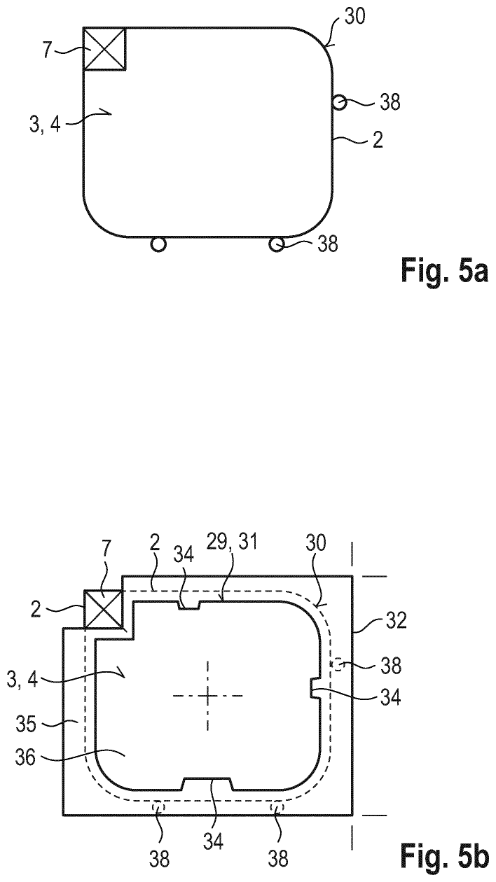

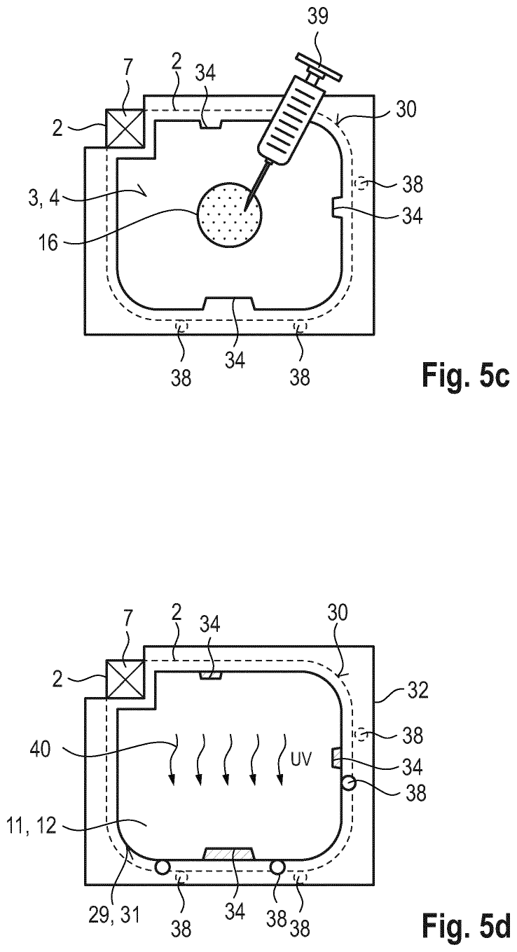

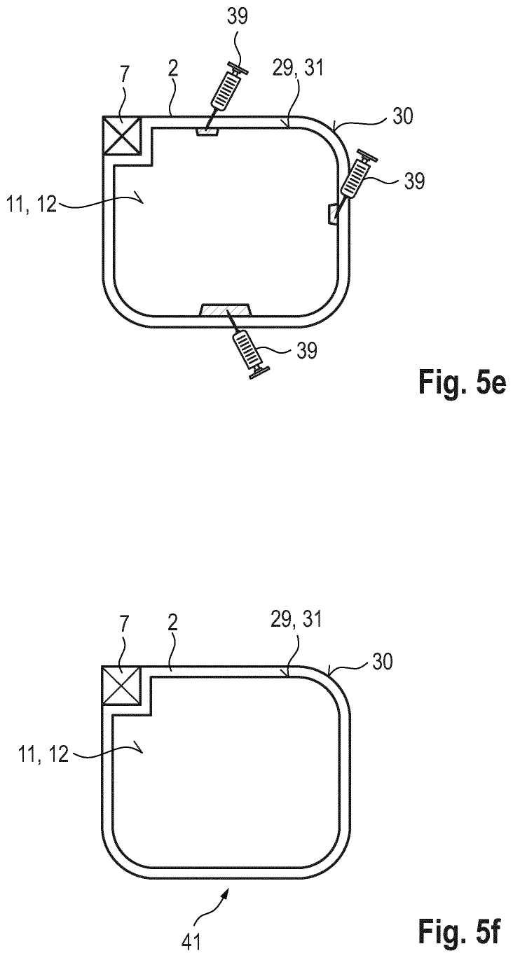

A mask is provided in a further step 22 (see FIG. 2). By preference, the mask comprises a frame and an opening arranged in the frame, for example a passage opening, and a number of projections, e.g. at least three projections, which extend from the frame into the opening. In this case, the frame is designed to at least partly cover the edge region of the surface of the optical waveguide and the edge region of the back-side surface of the optical component. Examples of this are shown in FIGS. 4 and 5.

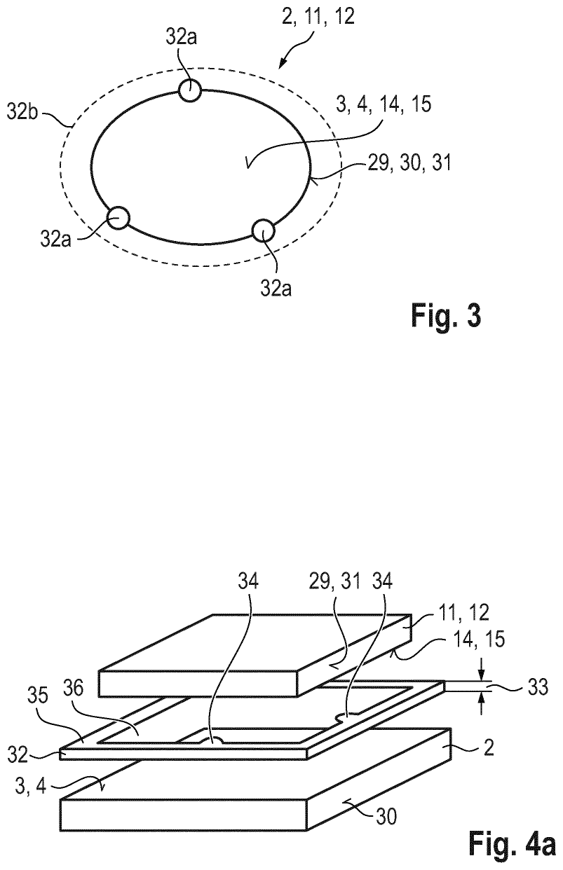

A plurality of masks can be used in an alternative. An example of this is shown schematically in FIG. 3. FIG. 3 shows a plan view of a surface which can be a surface 3, 4 of the optical waveguide 2 or a back-side surface 14, 15 of an optical component 11, 12. Three masks 32a are arranged in such a way on the edge region of the surface 3, 4, 14, 15 that they partly cover the edge region. By preference, the masks 32a protrude beyond the edge 29, 30, 31 in order to facilitate subsequent removal of the masks 32a. Optionally, a mask 32b that terminates flush with the edge 29, 30, 31 is arranged around the edge; this mask can be designed to protect the edge 29, 30, 31 from excess adhesive.

For example, the mask can consist of the following polymer materials: vinyl, polyvinyl chloride, silicone, polyacrylic, polyethylene terephthalate and polyolefins, and fluorinated films. By preference, the mask is self-adhesive. The mask can be manufactured by cutting.

In step 23, the mask is arranged on and preferably secured to, e.g. adhesively bonded to, the surface of the optical waveguide or the back-side surface of the optical component, in such a way that the edge region of the surface is at least partly covered. The mask can be applied, preferably adhesively bonded, in particular adhesively bonded all round, to either the optical waveguide or the optical component. The frame of the mask can rest on the respective surface, or it is only the projections that can rest on the respective surface, and the frame can rest against the edge of the respective surface. By preference, the mask is applied to the optical waveguide.

FIG. 4 schematically shows the arrangement of an optical waveguide 2, a mask 32 and an optical component 11, 12 in different views and variants. In this case, FIG. 4 (a) shows a perspective exploded view, in which a mask 32 is arranged on the optical waveguide 2, and an optical component, for example a lens 11, 12, is arranged on said mask. FIG. 4 (b) and FIG. 4 (c) each show a view from above. FIG. 4 (b) and 4 (c) differ in terms of the shape of the mask 32. In FIG. 4 (b), the outer boundary of the mask 32 corresponds to the outer edge 30 of the optical waveguide 2. In FIG. 4 (c), the mask 32 protrudes at least partially beyond the edge 30 of the optical waveguide 2 and the optical component 11, 12 in the shown plane, i.e. laterally. An input coupling device 7 is shown in FIG. 4 (b) and 4 (c). The input coupling device 7 can be a prism, mirror, diffractive element or hologram.

In the examples shown, the mask 32 comprises in each case an all-round frame 35, which has a closed embodiment in the variants shown, an opening 36 formed by the frame, which is a passage opening in the variants shown, and three projections 34, which extend laterally into the opening, i.e. protrude into the latter. The projections 34, marked in part by hatching, are embodied as areal or plane bulges which serve as spacers in the adhesion process. The thickness 33 of the mask 32 determines the thickness of the adhesive layer. In this context, typical values are found between 1 μm and 1 mm. Thicker layers are able to partly compensate the disadvantageous difference in the coefficients of thermal expansion of the optical waveguide 2 and lenses 11, 12.

As a result of the mask 32 covering the outer region of the optical waveguide 2, a circumferential boundary 37 of the optical waveguide 2 remains “free” after adhesive bonding. This circumferential boundary 37 or a part of this circumferential boundary 37 is not covered by the push/pull lenses 11, 12 either. In an alternative, the circumferential boundary 37 can be omitted, and it is possible to apply only the projections 34 as temporary spacer, i.e. apply these to the respective surfaces.

The adhesion of the mask 32 prevents circumvention by the adhesive and allows edge-free adhesion. The mask can be applied by means of a gripper, preferably a vacuum gripper. Markers or other optical auxiliary structures, e.g. the edge 30 of the optical waveguide 2, visible structures of the optical waveguide, the position of the picture generator or projector or of the input coupling device 7 or mechanical stops (see FIG. 5b), can serve for positioning purposes.

For example, for the positioning and alignment/adjustment of the optical components (optical waveguide and lenses), use is made of mechanical stops (3-point bearing) for the optical waveguide and the at least one optical component, e.g. the lens to be adhesively bonded. The contours of these components, for example, are used in the process. The outer contour of the lens is matched to the contour of the optical waveguide and optionally to the position of the input coupling region 7, e.g. during the preceding manufacturing, in particular the edging, of the lens. This and the further steps are illustrated in FIG. 5.

In step 24 (see FIG. 2), an adhesive 16 is applied to the masked surface of the optical waveguide 2 or the optical component 11, 12, e.g. introduced into the opening 36 of the mask 32. In the subsequent step 25, the back-side surface 14, 15 of the optical component 11, 12 and the surface 3, 4 of the optical waveguide 2 are placed on top of one another, for example placed on one another in floating fashion and/or using stops. In this way, the adhesive 16 can be distributed uniformly and an adjustment can be implemented by way of a lateral movement of the optical waveguide 2 and the optical component 11, 12 with respect to one another.

The adhesive 16 is cured in the subsequent step 26. The mask 32 is removed in a further step 27. Optionally, in a further step 28, the recesses caused by the projections 34 and/or the mask 32a can be filled with adhesive 16. Following step 27 or step 28, the method can be repeated with a further optical component 11, 12, for example a second lens. In this case, by means of the adhesive 16, the further optical component 11, 12 can be connected to the further optical component 11, 12 by way of the surface 3, 4 opposite the already adhesively bonded surface 3, 4 of the optical waveguide 2.

FIG. 5 schematically shows the steps 21 to 28 of an exemplary method. The optical waveguide 2 is initially aligned (see FIG. 5a). Mechanical stops 38 are used to this end. Subsequently, the mask 32, e.g. the masking tape, corresponding to the markers (see above) is applied (see FIG. 5b), and the adhesive 16 is subsequently applied (see FIG. 5c). The adhesive 16 is applied by means of dispensers or positive displacement pipette 39. The volume emerges from the free area, i.e. the area of the opening 36, of the mask 32 and mask thickness 33 plus an excess of 7% to 10%. Examples of adhesives 16 with a low refractive index are Norland Optical Adhesives, MY Polymers. The optical component 11, 12, e.g. the lens, is preferably applied “in floating fashion” such that the adhesive 16 is distributed homogeneously as a result of the relative movement and possible pressure, and the adhesive layer can be set. Further mechanical stops 38 are introduced to secure the final position (see FIG. 5d).

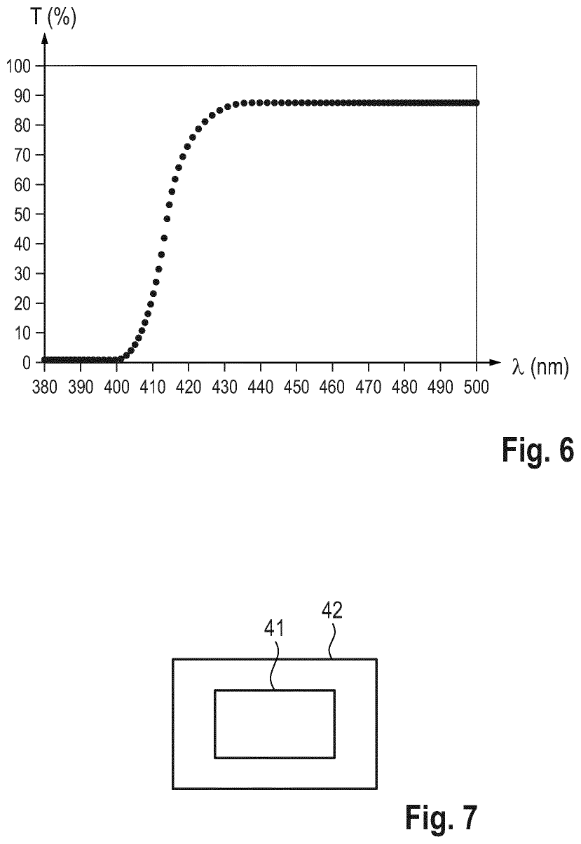

The curing of the adhesive 16 all over by means of UV light can preferably be implemented through the optical component 11, 12, e.g. the lens, wherein a wavelength of between 400 nm and 450 nm is preferred (420 nm are particularly preferred). This arises from the trade-off of the transmission of a lens made of lens material for glasses, wherein the transmission below approx. 380 nm is typically greatly reduced, and the decreasing absorption of the photoinitiator in the UV adhesive with increasing wavelength. FIG. 6 schematically shows the transmission T in percent for an exemplary optical component, e.g. the lens, as a function of the wavelength λ of the light, in the form of a diagram for a conventional optometric lens material (3.5 mm thick) with UV protection and blue-light filter (BlueGuard).

In the case in which the intention is to adhesively bond two lenses onto the optical waveguide, the first lens can in principle also cure through the optical waveguide. Since the optical waveguide can consist of a different material to the lenses, this would however require a second UV source (at a different wavelength). However, the second lens can subsequently no longer be cured through the optical waveguide, which is why curing through the lens is preferred. Nitrogen purging can be implemented during the curing in order to prevent the termination of the radical crosslinking reaction by oxygen.

As an alternative to the preferred passive alignment, all elements can be aligned actively on the basis of existing reference points (e.g.: contour of the circumferential boundary) or previously integrated optical markers on the optical waveguide and the lenses.

The mask 32, 32a, 32b is removed after curing (see FIG. 5e). The regions between the optical component 11, 12 and the optical waveguide becoming free as a result are preferably retrospectively filled with adhesive (see FIG. 5e). Further defects, e.g. air inclusions at the edge, can also be filled, and so a disturbing region (adhesive edge) is no longer identifiable at the end. The entire process can be repeated for the respectively other lens 11, 12 or a further optical component. An optical arrangement 41 produced by means of the method is shown in FIG. 5f.

The adhesion process described can be configured such that a circumferential boundary of the waveguide remains “free”; this can also serve again as a reference area in subsequent steps, e.g. during the integration of a push/pull waveguide compound structure into a glasses frame. This is moreover advantageous in that this reference area always has the same geometry independently of the required lens strengths and lens thicknesses (diopters) of the lenses.

In a further variant, the opening 36 is shaped such that it only encloses a surface region of the optical waveguide 2 which is embodied to ensure total-internal reflection. This surface region can then be adhesively bonded, i.e. coated, with an adhesive 16 which has a low refractive index suitable for ensuring total-internal reflection. Following the removal of the mask 32, the remaining surface regions of the optical waveguide 2 can be adhesively bonded to the optical element using a further adhesive, which preferably has a better adhesion than the previously used adhesive 16, e.g.: epoxy resin, cyanoacrylate, silicone rubber, urethane methacrylate and polymethacrylate. In particular, the depressions or gaps or intermediate spaces between the optical waveguide 2 and the optical component 3, 4 that have arisen on account of the mask can be filled with a corresponding further adhesive. This variant offers optimal strength of the adhesive connection.

FIG. 7 schematically shows an image reproduction apparatus 42, e.g. a head-mounted display 1, or image capture apparatus 42 which comprises at least one optical arrangement 41.

### LIST OF REFERENCE SIGNS

1 Head-mounted displays
2 Optical waveguide
3 Surface
4 Surface
5 Layer made of low-index medium
6 Beam path of an imaging path of a virtual image representation
7 Input coupling device
8 Output coupling device
9 Eyebox, eye
10 Beam path of an imaging path of an image representation of the real surroundings
11 Optical component, lens, push lens
12 Optical component, lens, pull lens
13 Surface
14 Surface
15 Surface
16 Adhesive
21 Providing an optical waveguide and an optical component
22 Providing a mask
23 Arranging the mask on the front-side surface of the optical waveguide or on the back-side surface of the optical component
24 Applying adhesive
25 Placing the back-side surface of the optical component and the front-side surface of the optical waveguide on one another
26 Curing the adhesive
27 Removing the mask
28 Filling depressions caused by the projections with adhesive
29 Edge
30 Edge
31 Edge
32 Mask
32a Mask
32b Mask
33 Thickness
34 Projection
35 Frame
36 Opening
37 Circumferential boundary
38 Mechanical stop
39 Dispenser, positive displacement pipette
40 UV curing
41 Optical arrangement
42 Image reproduction apparatus or image capture apparatus
T Transmission
λ Wavelength

1-20. (canceled)

21. A method for producing an optical arrangement comprising at least one optical waveguide and at least one optical component, the method comprising:
providing an optical waveguide, which has a surface, and an optical component, which has a back-side surface, wherein the surface of the optical waveguide and the back-side surface of the optical component are configured for arrangement on one another in a manner facing one another and have a surface geometry matched to one another;
providing at least one mask which is configured to at least partly cover an edge region of the surface of the optical waveguide and of the back-side surface of the optical component;
arranging the mask on the surface of the optical waveguide or on the back-side surface of the optical component such that the edge region is at least partly covered;
applying an adhesive to the surface of the optical waveguide or to the back-side surface of the optical component on which the mask is arranged;
placing the back-side surface of the optical component and the surface of the optical waveguide on top of one another;
curing the adhesive; and
removing the mask.

22. The method of claim 21, wherein the mask comprises a frame and an opening arranged in the frame, and wherein the adhesive is introduced into the opening.

23. The method of claim 22, wherein the mask comprises a plurality of projections that extend from the frame into the opening.

24. The method of claim 21, wherein the surface of the optical waveguide comprises a zone configured for total-internal reflection, and the mask is configured such that an area of the optical waveguide that is not covered by the mask is matched to the zone configured for total-internal reflection.

25. The method of claim 21, wherein the optical component is fully manufactured in relation to the optical effect.

26. The method of claim 21, wherein the optical component comprises a coated front-side surface.

27. The method of claim 21, wherein on account of the mask, depressions that have arisen as a result of removing the mask are filled with adhesive.

28. The method of claim 21, wherein, following the removal of the mask, a further adhesive with a composition that deviates from the adhesive applied previously is introduced between the surface of the optical waveguide and the back-side surface of the optical component.

29. The method of claim 21, wherein the adhesive is cured through the optical component.

30. The method of claim 21, wherein the optical component comprises a lens and/or an optical element configured to correct a refractive error in an imaging path of a real image representation of a surroundings and/or to correct a refractive error in an imaging path of a virtual image representation and/or to focus a virtual image representation in an imaging path of a virtual image representation is provided.

31. The method of claim 21, wherein the optical component comprises a back-side surface with a plane or curved embodiment, and the optical waveguide comprises a plane or a curved surface.

32. The method of claim 21, wherein the optical component comprises an oxidic back-side surface and/or the optical waveguide comprises an oxidic surface.

33. The method of claim 32, wherein the oxidic surface is activated for the creation of reactive groups.

34. The method of claim 21, wherein the mask is arranged via a gripper and/or the adhesive is introduced into the opening via a dispenser or a positive displacement pipette.

35. The method of claim 21, wherein a position of the optical waveguide and/or the mask and/or the optical component in relation to at least one other of the aforementioned components is adjusted via at least one mechanical stop.

36. The method of claim 21, wherein the adhesive has a lower refractive index than the optical waveguide, or the optical waveguide comprises a coating comprising a material that has a lower refractive index than the optical waveguide.

37. An optical arrangement produced according to the method of claim 21.

38. The optical arrangement of claim 37, comprising a viewing window for output coupling a virtual image representation in the direction of an eyebox.

39. An image reproduction apparatus, comprising the optical arrangement of claim 37.

40. An image capture apparatus, comprising the optical arrangement of claim 37.
